(19) United States
(12) Patent Application Publication
(10) Pub. No.: US 2002/0024632 A1
(43) Pub. Date: Feb. 28, 2002

(54) Multifocal lens

(76) Inventor: KIYOSHI YAMAGUCHI, ATAMI-SHI (JP)

Correspondence Address: SHLESINGER, ARKWRIGHT & GARVEY LLP, 3000 South Eads Street, Arlington, VA, 22202, US

(21) Appl. No.: 09/824,858

(22) Filed: Apr. 4, 2001

(30) Foreign Application Priority Data
Aug. 22, 2000 (JP) 2000-251414

(51) Int. Cl. G02C 7/02; G02C 7/06

(52) U.S. Cl. 351/168; 351/159

(57) ABSTRACT

This invention prevents distortion in a portion area for farness in a multifocal lens. Therefore, the multifocal lens comprises a portion area for farness 12 molded so as to have a first curvature radius, and a portion area for nearness 13 molded so as to have a second curvature radius shorter than the first curvature radius, and a side portion prescribing an edge portion of the lens has a predetermined thickness irrespective of the portion area for farness and the portion area for nearness. For example, the thickness of the side portion is set to be entirely equal in the portion area for farness and the portion area for nearness by progressively changing the first curvature radius toward the side portion of the lens. Thus, distortion can be prevented in the portion area for farness. Further, if the thickness of the lens side portion is changed in accordance with the direction of a lens axial angle, it is possible to prevent distortion in the portion area for farness and cope with astigmatism.

### BACKGROUND OF THE INVENTION

1. Field of the Invention

The present invention relates to a multifocal lens used as a lens for spectacles for both farness and nearness, and particularly relates to a multifocal lens able to prevent distortion in a portion for farness.

2. Description of the Background Art

A double focal lens used for both farness and nearness as one lens is generally known. Further, a triple focal lens formed by adding a portion for an intermediate converging degree to portions for farness and nearness is also known. In these lenses, a sharp boundary line is seen between (boundary) an area for farness (a portion for farness) and an area for nearness (a portion for nearness). Therefore, a so-called multifocal lens for progressively changing the converging degree in an intermediate portion of the lens is proposed.

An outside curve on an observation object side surface of the above multifocal lens has a portion area for farness located in an upper portion of the lens and a portion area for nearness located in a lower portion of the lens. The portion area for farness is a spherical portion having a predetermined relatively long radius of curvature, and the portion area for nearness is a spherical portion having a predetermined relatively short radius of curvature. An internal face curve on an eyeball side surface of this multifocal lens is constructed by a spherical surface having a predetermined radius of curvature.

The above multifocal lens is generally molded from a lens having a TC axial angle of 90 degrees on its external face. However, radii of curvature in the portion area for farness and the portion area for nearness are different from each other. Accordingly, lens thicknesses are inevitably different from each other in lens side areas (lens edge sides). As a result, distortion is caused leftward and rightward in the portion area for farness. Namely, no generation of large astigmatism and distortional aberration can be avoided in the portion for farness. For example, problems exist in that an object is defocused at an intermediate distance, and a user of spectacles senses image shaking and has an uncomfortable feeling when the user moves the user's head. Further, the portion area for farness and the portion area for nearness are narrowed.

### SUMMARY OF THE INVENTION

An object of the present invention is to provide a multifocal lens able to particularly prevent distortion in a portion area for farness.

In accordance with the present invention, it is possible to obtain a multifocal lens comprising a portion area for farness molded so as to have a first curvature radius, and a portion area for nearness molded so as to have a second curvature radius equal to or greater than the first curvature radius, and characterized in that a side portion prescribing an edge portion of said lens has a predetermined thickness irrespective of said portion area for farness and said portion area for nearness. This multifocal lens is molded from a lens having a TC axial angle of 90 degrees on its external face.

For example, the thickness of said side portion is set to be entirely equal in said portion area for farness and said portion area for nearness by progressively changing the first curvature radius toward said side portion.

Further, in accordance with the present invention, it is possible to obtain a multifocal lens comprising a portion area for farness molded so as to have a first curvature radius, and a portion area for nearness molded so as to have a second curvature radius equal to or greater than the first curvature radius, and characterized in that the thickness of a side portion prescribing an edge portion of said lens is changed in accordance with the direction of a lens axial angle. This multifocal lens is molded from a lens having a TC axial angle of 90 degrees on its external face.

### BRIEF DESCRIPTION OF THE DRAWINGS

FIG. 1 is a view for explaining one example of a multifocal lens in the present invention.

FIG. 2 is a front view showing one example of the multifocal lens in the present invention.

### DESCRIPTION OF THE PREFERRED EMBODIMENTS

The present invention will next be explained with reference to the drawings.

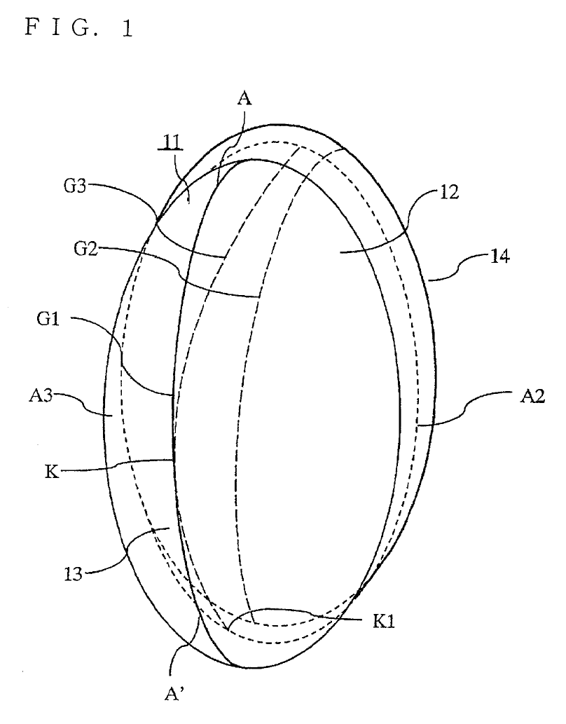

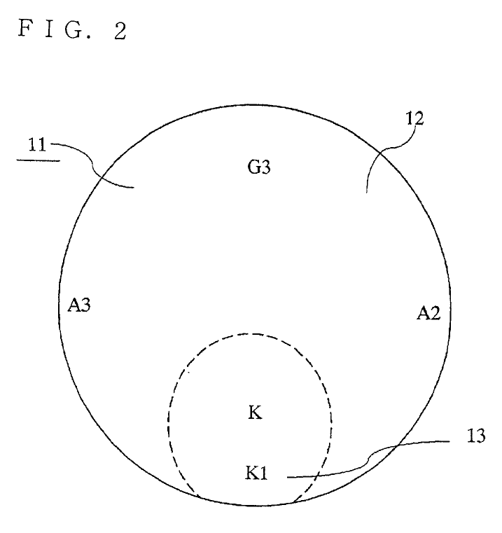

With reference to FIGS. 1 and 2, for example, a multifocal lens shown in these figures is molded from a lens having a TC axial angle of 90 degrees on its external face. An outside face 11 of this multifocal lens as an observation object side surface has a portion area for farness 12 located in an upper portion and a portion area for nearness 13 located in a lower portion. The portion area for farness 12 is a spherical portion having a predetermined relatively long radius of curvature (a first curvature radius), and the portion area for nearness 13 has a spherical portion having a predetermined relatively short radius of curvature (a second curvature radius as a curvature radius equal to or greater than the first curvature radius). An internal face 14 as an eyeball side surface of this multifocal lens is constructed by a spherical surface having a predetermined curvature radius.

In FIG. 1, the thickness of a central portion shown by a line A-A′ and extending from an upper end of the lens to a lower end of the lens is thick in comparison with side portions (outer circumferential portions) A2 and A3 prescribing left-hand and right-hand edges of the lens. Namely, the thickness of the lens is gradually reduced from the central portion toward the side portions A2 and A3.

The above portion area for farness 12 having the predetermined relatively long curvature radius is formed by grinding an upper portion of the central portion of the lens by using a grinding jig, etc. Namely, a portion shown by reference numeral GI in FIG. 1 is ground by using the grinding jig, etc. until a position shown by a broken line G3 so that the portion area for farness 12 is formed. In FIG. 1, a portion shown by a broken line G2 is a portion showing the internal face 14 of the lens.

In contrast to this, a lower portion of the central portion of the lens is ground by the grinding jig, etc. so that the above portion area for nearness 13 having the predetermined relatively short curvature radius is formed. Namely, in FIG. 1, the lower portion of the central portion of the lens is ground by using the grinding jig, etc. until a position shown by a broken line K1 so that the portion area for nearness 13 is formed. As a result, a thickest vertex portion K is formed in the central portion shown by the line A-A′, and the portion area for farness 12 is formed in a portion along a reference numeral G3 from a portion shown by a reference numeral K. The portion area for nearness 13 is formed in a portion along a reference numeral K1 from the portion shown by the reference numeral K.

When the portion area for farness 12 and the portion area for nearness 13 are formed as mentioned above, thicknesses of the side portions A2 and A3 of the lens are different from each other since the portion area for farness 12 and the portion area for nearness 13 are different from each other in curvature radius. Namely, a side portion corresponding to the portion area for farness 12 and a side portion corresponding to the portion area for nearness 13 are different from each other in thickness so that distortion is inevitably caused on left-hand and right-hand sides of the portion area for farness 12.

To prevent such disadvantages, the curvature radius of the portion area for farness 12 is progressively changed toward the side portions. Thus, the thicknesses of the side portions (outer circumferential portions) A2 and A3 are set to be entirely equal to each other irrespective of the portion area for farness 12 and the portion area for nearness 13. Namely, the curvature radius of the portion area for farness 12 is progressively changed toward the side portions such that the thicknesses of the side portions are equal to each other irrespective of the portion area for farness 12 and the portion area for nearness 13. As a result, distortion can be prevented in the portion area for farness 12, and astigmatism and distortional aberration are not caused in the portion area for farness.

In the above example, the thicknesses of the side portions (outer circumferential portions) are set to be entirely equal to each other irrespective of the portion area for farness 12 and the portion area for nearness 13. However, the thicknesses of the side portions are changed in accordance with the direction of a lens axial angle when astigmatism is considered. Namely, it is possible to cope with astigmatism if the thicknesses of the side portions are changed in accordance with the direction of the lens axial angle.

As mentioned above, in the present invention, the thickness of an edge portion of the lens is set to be equal irrespective of the portion area for farness and the portion area for nearness in the multifocal lens having the portion area for farness and the portion area for nearness. Accordingly, there is an effect in that distortion can be particularly prevented in the portion area for farness.

Further, in the present invention, the thickness of the edge portion of the lens is changed in accordance with the direction of a lens axial angle. Accordingly, there are effects in that distortion is prevented in the portion area for farness and it is also possible to cope with astigmatism.

What is claimed is:

1. A multifocal lens comprising a portion area for farness molded so as to have a first curvature radius, and a portion area for nearness molded so as to have a second curvature radius equal to or greater than the first curvature radius, and characterized in that a side portion prescribing an edge portion of said lens has a predetermined thickness irrespective of said portion area for farness and said portion area for nearness.

2. The multifocal lens as defined in claim 1, wherein said side portion is molded such that the thickness of the side portion is entirely equal in said portion area for farness and said portion area for nearness.

3. The multifocal lens as defined in claim 1 or 2, wherein said first curvature radius is progressively changed toward said side portion.

4. A multifocal lens comprising a portion area for farness molded so as to have a first curvature radius, and a portion area for nearness molded so as to have a second curvature radius equal to or greater than the first curvature radius, and characterized in that the thickness of a side portion prescribing an edge portion of said lens is changed in accordance with the direction of a lens axial angle.

5. The multifocal lens as defined in any one of claims 1 to 4, wherein the multifocal lens is molded from a lens having a TC axial angle of 90 degrees on its external face.
